(19) United States
(12) Patent Application Publication
(10) Pub. No.: US 2017/0023394 A1
(43) Pub. Date: Jan. 26, 2017

(54) System and Method for Unmanned Aerial Vehicle Monitoring of Petroleum Storage Container Contents

(71) Applicant: Imran Akbar, Redwood City, CA (US)

(72) Inventor: Imran Akbar, Redwood City, CA (US)

(21) Appl. No.: 14/809,203

(22) Filed: Jul. 25, 2015

(51) Int. Cl. G01F 23/00; B64C 39/02

(52) U.S. Cl. CPC G01F 23/0061; B64C 39/024; B64D 47/08

(57) ABSTRACT

A system and method for determining the amount of petroleum present in petroleum storage containers, by means of an unmanned aerial vehicle flying in proximity to said containers and collecting data. This data includes position and distance measurements in relation to the unmanned aerial vehicle and storage containers which allow a calculation of the amount of petroleum contained within the containers.

### BACKGROUND OF THE INVENTION

The field of this invention relates to data collection regarding petroleum storage facilities. More specifically, it relates to a method and system for generating data about the amount of material being stored in petroleum storage containers.

Over a quarter of the world's energy requirements are met by petroleum products, such as petroleum, diesel, and kerosene oil. Current consumption stands at approximately $1.7 trillion U.S. dollars a year, and is increasing steadily. These substances are primarily used for motive power to run engines in vehicles including automotive cars, airplanes, ships, and locomotives. As one of the world's most valuable commodities, petroleum is traded through, large financial contracts between oil companies and suppliers, with the price of petroleum set by the prevailing market supply and demand. Due to its rather inelastic nature, demand for petroleum changes slowly and is largely impacted only by macroeconomic trends. However, supply can change drastically based on political events, production cuts, and transportation issues. As such, there is a market need for real-time information on the supply of petroleum in key markets around the world. This information typically involves tracking oil shipping tankers around the world's oceans and ports, knowing how much petroleum is flowing through key pipelines, and figuring out how much is present in storage containers. Oil tankers can be tracked through antennas at major ports, or by satellites which listen in to data transmissions from ship transponders, which identify the ship and its position. The issue of pipelines flows is still an open problem, as it's very difficult to design a non-invasive/remote sensor capable of detecting flow rates in pipelines.

Due to the geographically distributed nature of petroleum storage containers in the world and the private ownership of each container, data from the source (such as sensors placed inside each container) is not readily available. However, due to the valuable nature of the information, there have been a number of attempts to ascertain estimates of the amount of petroleum stored in containers.

There are a number of types of petroleum storage containers in use around the world used for temporary storage of crude oil and other products until they are ready to be transported further along the supply chain, or processed at a refinery. The most common type of petroleum storage container is an external floating-roof tank (EFRT), typically used to store crude oil. These tanks are vertical and cylindrical in geometry, with storage capacities of up to 1.5 million barrels of hydrocarbons and diameters in excess of 100 meters. They are constructed from steel or plastic, and have a roof which can rise or fall based on the amount of petroleum present within the tank. An internal floating-roof tank (IFRT) may be selected for greater safety, in which case the tank's floating roof is supplemented with a second roof above it, which is fixed in place. Open top tanks are seldom used due to the evaporative losses from the petroleum's volatile nature and risk of fire, while fixed-roof tanks are typically only used for products other than crude oil which have low vapor pressures. When the storage tanks are located near strategic oil pipelines, they are known as “storage hubs” or “tank farms”.

Government agencies in various countries, such as the Energy Information Agency (EIA) in the United States, release publicly available data related to petroleum storage container levels on a regular basis, but due to the time it takes to survey each individual stakeholder that provides source data, there is a delay of at least a week before it becomes available.

There have been two attempts at providing more accurate and timely data related to petroleum storage containers, both involving capturing and analysing photos of the containers. The first approach is exemplified by the strategy of Genscape, Inc., in which helicopters are employed to fly in proximity to strategic petroleum storage containers, fitted with infrared cameras that take angled shots of the oil tanks. As the petroleum inside the tanks is maintained at a different temperature than the atmosphere above the petroleum, an infrared image can identify the height of the petroleum inside the tank by means of edge detection algorithms. Given the dimensions of the tanks (often cylindrical with a known diameter), a calculation of the height multiplied by the cross-sectional area of the tank then yields the volume of petroleum stored within it.

The disadvantage of this approach is that it is extremely expensive due to the cost of the helicopter itself and insurance coverage, in addition to the wages of the pilot and the operator of the camera. Furthermore, the high cost of running the flight means that the data can only be collected at a low frequency, such as once a week—often slower than the frequency with which the storage levels change. Requiring an oblique image of the side of the tank also means that human analysis is required of the images, in order to correct for the angle of the camera and its position. As infrared cameras are often much lower resolution than optical cameras, the accuracy of such a measurement is not incredibly good.

The second approach is similar in its use of imagery, but different in its collection and analysis methods. Satellites stationed in outer space, including those in low-earth orbit and geostationary orbit, can utilize image sensors to produce approximately 1-meter resolution pictures of areas containing petroleum storage containers. As can be seen in sample images provided by DigitalGlobe, Inc., further analysis of the images is necessary to determine the amount of petroleum being stored within. If the container is an EFRT, a shadow will be cast on the top surface of the roof whenever the sun is positioned at an angle, and the tank is not completely full. Thus, by measuring the length of the shadow on the roof of such tanks, an estimate of its current storage level can be determined. However, such a measurement is both rough in its accuracy, and expensive due to the cost of launching satellites in space, which can be upwards of a million dollars. In addition, adverse weather conditions may obscure the satellite's view for days at a time, eliminating any possibility of obtaining a measurement. While such an analysis will provide data for all EFRTs in an area, it does not handle the minority of tanks which are IFRTs, and as such is incomplete in its scope.

There have been a number of previous attempts to solve some of the problems associated with remotely measuring the levels of petroleum storage tanks. For example, U.S. Pat. No. 8,842,874B1 (2010), a “Method and system for determining an amount of a liquid energy commodity stored in a particular location” mentions analyzing images of the tanks, but does not specify how one skilled in the an actually collects this data. Furthermore, image processing of storage tank data is not very accurate, nor easily automatable. Other patents, such as U.S. Ser. No. 07/664,320 (1991) provide liquid level sensors (such as float sensors) that cannot be used for remote sensing without physical access to the storage tanks themselves. Another remote-sensing technique is mentioned in application U.S. 20140363084A1, “Oil Tank Farm Storage Monitoring,” but because this relies on satellite imagery and analysis of shadows, it is unreliable and inaccurate.

### BRIEF SUMMARY OF THE INVENTION

The foregoing and other features and advantages of preferred embodiments of the present invention will be more readily apparent from the following detailed description. The detailed description proceeds with references to the accompanying drawings.

The features and advantages described in the specification are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

This invention makes use of an unmanned aerial vehicle (UAV), colloquially known as a drone, for collecting data about petroleum storage containers in a manner that is cost-effective and extremely accurate. The UAV is flown directly above, or in proximity to each petroleum storage container that is intended to be measured. As it flies, the UAV collects data from onboard distance sensors which are then processed and analyzed by an algorithm to determine the amount of petroleum present in each storage container. This result is then transmitted over a network such as the Internet for further distribution, via e-mail, a real-time feed, a mobile application, or publishing on the World Wide Web.

The foregoing and other features and advantages of preferred embodiments of the present invention will be more readily apparent from the following detailed description. The detailed description proceeds with references to the accompanying drawings.

### BRIEF DESCRIPTION OF THE SEVERAL VIEWS OF THE DRAWING

Preferred embodiments of the present invention are described with reference to the following drawings, wherein:

FIG. 1 is a diagram illustrating an exemplary UAV measurement system;

FIG. 2 is a diagram illustrating a quadcopter flying overhead petroleum storage containers, measuring the distance to each container's roof;

FIG. 3 is a diagram illustrating a fixed-wing aircraft flying overhead petroleum storage containers, measuring the distance to each container's roof;

FIG. 4 is a diagram illustrating the flight of a UAV in a pre-programmed flight path overhead a. multitude of petroleum storage containers;

FIG. 5 is a diagram illustrating a UAV positioned at an oblique angle to a petroleum storage container with an infrared image sensor;

FIG. 6 is a flowchart illustrating an algorithm for determining the amount of petroleum being stored within one or more storage containers;

FIG. 7 is a diagram illustrating the distances from the ground to the roof of the tank, the lip of the tank, the bottom of the UAV, and from the UAV to the top of the tank.

### DETAILED DESCRIPTION OF THE INVENTION

A preferred embodiment of the present invention is now described with reference to the figures where like reference numbers indicate Identical or functionally-similar elements. Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

Certain aspects of the present invention include process steps and instructions described herein in the form of an algorithm. It should be noted that the process steps and instructions of the present invention could be embodied in software, firmware, or hardware, and when embodied in software, could be downloaded to reside on and be operated from different apparatuses used by a variety of operating systems.

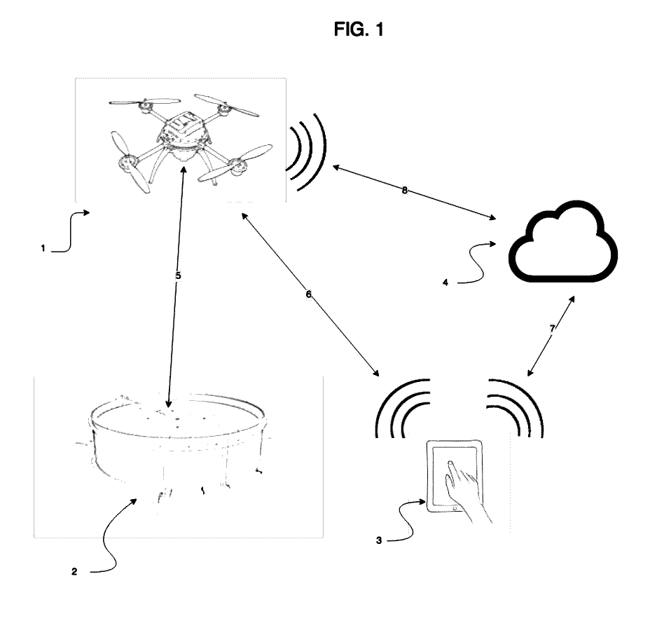

FIG 1. is a block diagram representing an exemplary measurement system. It is composed of the UAV 1, which includes, but is not limited to, unmanned multi-rotor craft, helicopters, quadcopters, fixed-wing airplanes, lighter-than-air craft, and tethered aerostats. The UAV 1 includes a plurality of sensors, including, but not limited to, a Global Positioning System (GPS) sensor, a laser distance meter (colloquially known as a laser rangefinder), a laser distance and ranging (LIDAR) sensor, an ultrasonic distance meter, an optical image sensor (camera), a stereo optical image sensor (stereo vision camera), a radio distance and ranging (RADAR) sensor, an infrared image sensor (infrared camera), or a millimeter-wave sensor (not illustrated). The UAV 1 also includes one or more batteries or capacitors, including, but not limited to, lithium-ion batteries, nickel-cadmium, batteries, and other electrical energy storage devices (not illustrated). In addition, the UAV 1 includes an onboard flight computer (not illustrated). The communications link 8 includes, but is not limited to, the Internet, an intranet, a wired Local Area Network (LAN), a wireless LAN (WLAN), a Wide Area Network (WAN), a Metropolitan Area Network (MAN), the Public Switched Telephone Network (PSTN), and other types of communications providing voice, video, or data communications. The short-range communications link 6 includes, but is not limited to, radio, IEEE 802.11b, IEEE 802.11g, IEEE 802.11n, Bluetooth, microwave, and other types of direct point-to-point communication links. The communications links 6, 8 may also include one or more servers or access points (AP) including wired and wireless access points (WAP) (not illustrated). The petroleum storage tank 2 includes, but is not limited to, external floating-roof tanks, internal floating-roof tanks, open top tanks, fixed-roof tanks, and closed floating-roof tanks of any geometry. The computers 3, 4 include, but are not limited to, desktop computers, laptop computers, cloud computers, tablet computers, smartphones, headless computers, and other devices with central processing units (CPUs). In one embodiment, the computers 3 process data from the UAV before transmitting it over the network 7. In another embodiment, the flight computer on board the UAV 1 sends the data directly to the computers 4 for further processing. The UAV may include commercially-available products including the DJI Phantom, the Parrot AR, or the 3DR Solo. The aforementioned batteries in the UAV 1 typically have a lifetime of approximately fifteen minutes. For this application, however, because petroleum storage containers are typically grouped together geographically in a small area of a few square kilometers, the UAV 1 can easily fly over most of the storage containers in a single flight. To cover multiple areas of petroleum storage containers, multiple UAVs can be operated in parallel.

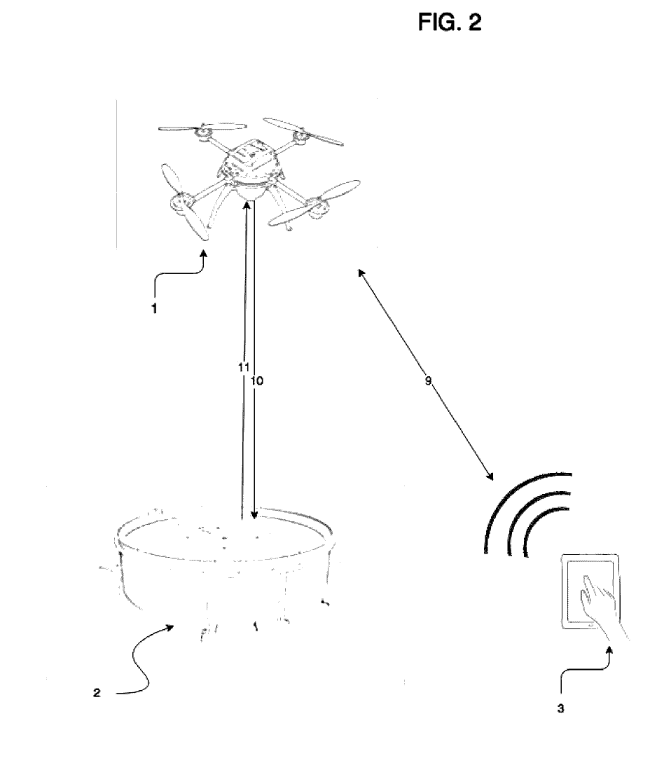

FIG 2. is a block diagram representing a measurement technique of the invention. In this particular embodiment, the UAV 1 contains a distance meter, including, but not limited to, a laser distance meter, or an ultrasonic distance meter, which transmits a signal 10 in the direction of the petroleum storage container 2, such that a reflection of the signal 11 is received back at the UAV 1. By using time-of-flight (TOF) techniques, the distance to the container 2 can be determined by dividing the duration of the flight of she signal by the speed of the transmitting medium (for example, the speed of light). This measurement can then be transmitted to the computer 9 wirelessly.

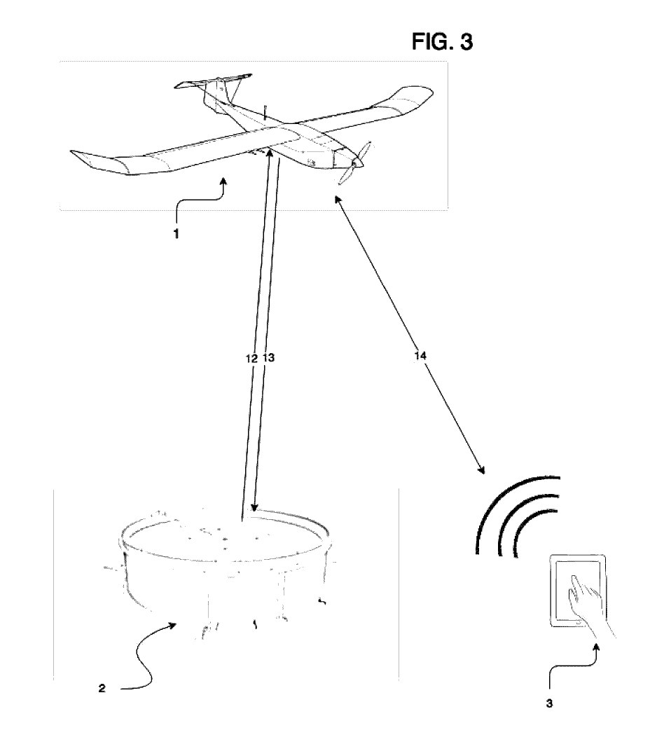

FIG 3. is a block diagram illustrating an alternate embodiment of the invention, in which the UAV 1 is a fixed-wing airplane. The UAV 1 contains a distance meter, including, but not limited to, a laser distance meter, or an ultrasonic distance meter, which transmits a signal 13 in the direction of the petroleum storage container 2, such that a reflection of the signal 12 is received back at the UAV 1. By using time-of-flight (TOF) techniques, the distance to the container 2 can be determined by dividing the duration of the flight of the signal by the speed of the transmitting medium (for example, the speed of light). This measurement can then be transmitted to the computer 14 wirelessly.

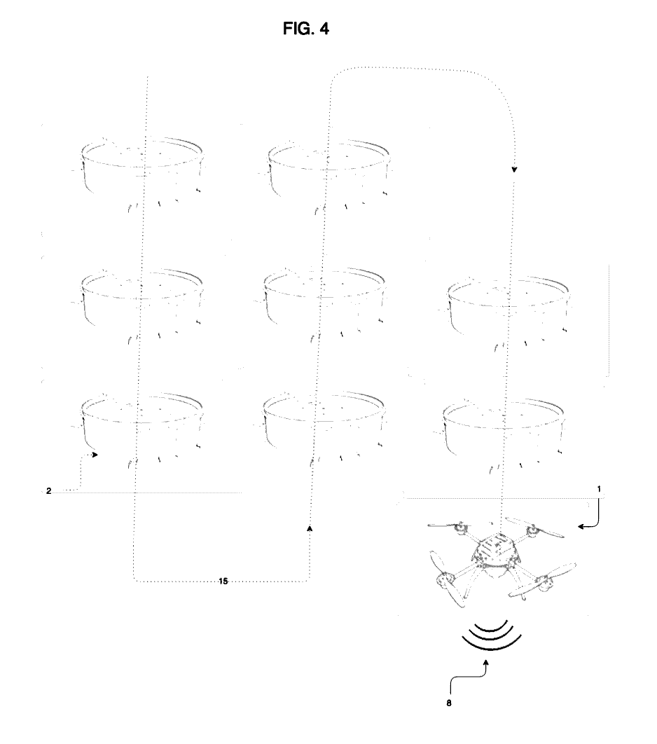

FIG 4. is a block diagram illustrating the UAV 1 following a pre-programmed flight path 15 over a multitude of petroleum storage containers 2. Due to the difficulty of flying the UAV remotely, computer algorithms are typically used to program the flight path in advance, to ensure an accurate flight and to free the human operator from struggling with the controls. These take the form of a feedback loop, with inputs of the expected position of the craft at that point in time as well as its current position and speed from the GPS sensor onboard, and outputs being the power provided to each motor of the craft and any positions of the flaps. This ends up not only reducing the cost of flight, but ensures a repeatable process for collecting data. The measurement data as well as the telemetry data necessary for the autopilot is transferred to and from the UAV 1 over the wireless link 8.

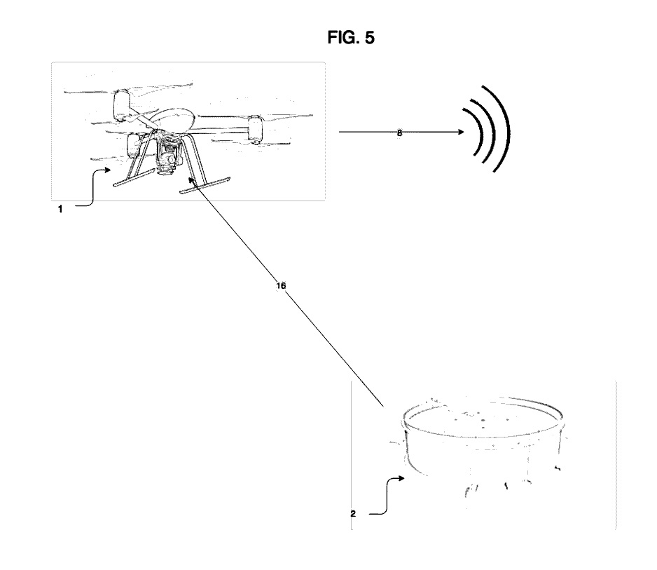

FIG 5. is a block diagram illustrating an alternate embodiment of the invention, in which the UAV 1 is outfitted with an infrared image sensor and positioned at an angle to the petroleum storage container 2, which is art internal floating-roof tank (IFRT). Light rays 16 from the container 2 are reflected off the surface and forms an image at the focal point of the camera on the UAV 1. These images may then be transmitted over a wireless link 8 for further processing to a computer (not illustrated).

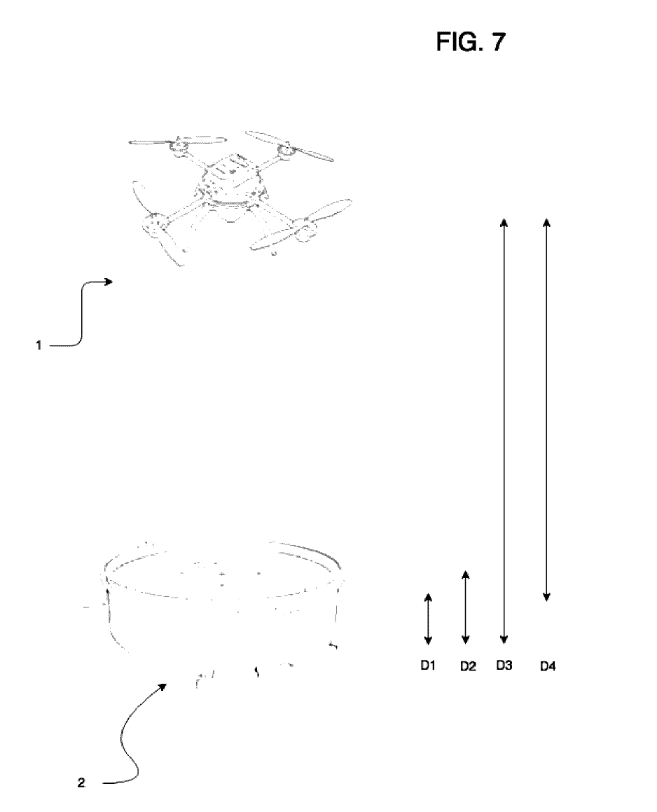

FIG. 7. is a block diagram illustrating the relevant distances used in the calculation of the amount of petroleum stored in the storage containers 2 as measured by the UAV 1. D1 is the distance from ground level up to the top of the floating roof of the container 2. D2 is the distance from ground level up to the top lip of the container 2, which is also its maximum height. D3 is the distance from ground level up to the bottom of the UAV 1. D4 is the distance from the bottom of the UAV 1 to the top of the floating roof of the container 2.

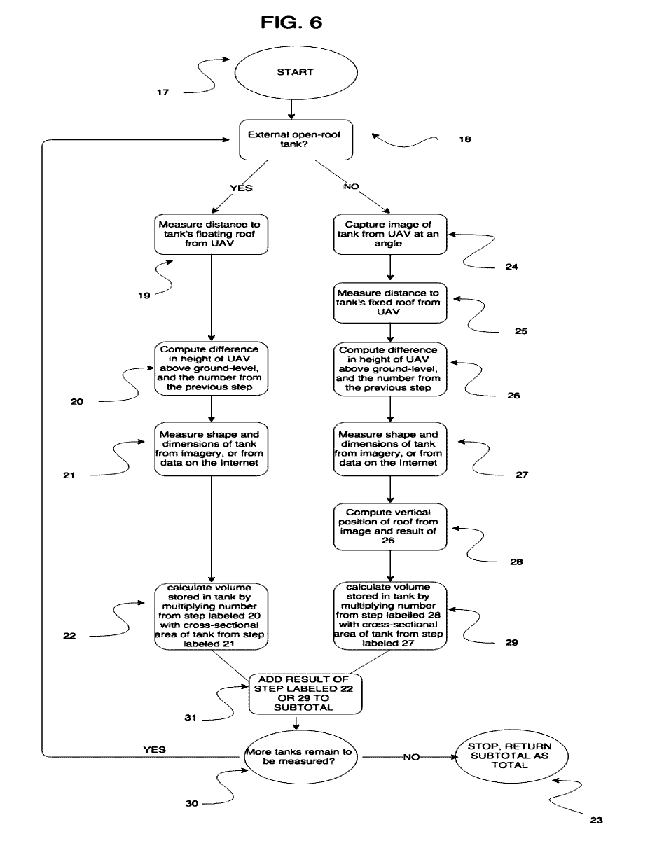

FIG 6. is a flowchart illustrating the algorithm processed in order to determine the amount of petroleum stored in one or more storage containers 2. The UAV 1 flies either directly overhead or in proximity to each storage container intended to be measured 2. The UAV 1 is outfitted with a GPS sensor (not illustrated) in order to guide it to the correct position in proximity to each storage container 2, and single or multiple sensors (not illustrated) are utilized to determine the amount of petroleum stored in each container.

Depending on the type of the storage container being measured, one or more of the aforementioned sensors will be positioned at the bottom of the UAV and pointed in the direction of the storage container during its flight. We begin the algorithm at 17, and initialize a variable storing the total sum of petroleum to 0. The first step 18 is to evaluate whether the tank is an external or internal floating-roof tank. In the case of measuring an EFRT, the UAV is fitted with a distance meter of some type; this may be any of the previously mentioned sensors, such as laser or ultrasonic meters. For IFRTs, the UAV is fitted with an infrared image sensor or millimeter-wave sensor in order to see the liquid level of a tank.

The next step 19 for an EFRT is to measure the distance from the bottom of the UAV to the top of the floating-roof tank. In the case of distance sensors, because the altitude of the craft 1 above

ground-level is known to within a centimeter (in the case of real-time kinematic GPS), the distance measured when the craft is positioned overhead the EFRT is a proxy for the height of the roof within the tank 2. In practice, multiple readings from the sensors will be taken within a quick interval and subsequent statistical operations may be applied, such as averaging or noise filtering. Next, the result of step 19 is subtracted from the measured height of the UAV 1 to produce the height of the roof above ground level, 20. As the roof of the EFRT 2 rises and falls with the level of the petroleum inside the container, knowing the height of the roof allows a calculation of the total volume being stored in the tank. To do this, a measurement or lookup operation 21 is performed (in the case of existing knowledge on the Internet or in a database) to ascertain the dimensions and geometry of the tank. If such knowledge is not available, the data from the distance meter and/or image sensor can be used to establish the dimensions and geometry of the tank. The amount of petroleum then stored in the tank 2 is established in step 22 by multiplying the height obtained in 20 by the cross-sectional area of the tank 2 established in step 21. For example, as almost all EFRTs are cylindrical in geometry, the equation for calculating the volume stored within it is =(pi*radiuŝ2)*(height of floating roof).

In the case of an IFRT, the algorithm proceeds along an alternate branch after step 18. At least one image is taken in step 24 of the IFRT 2 from the UAV 1 with the camera positioned at an angle, such that the side profile of the IFRT is visible to the camera. The distance meter on the UAV 1 is then utilized to measure the distance from the UAV 1 to the top of the IFRT's 2 fixed roof. At step 26, the result of step 25 is subtracted from the measured height of the UAV 1. to produce the height of the roof above ground level. Next, at step 27, a measurement or lookup operation is performed (in the case of existing knowledge on the Internet or in a database) to ascertain the dimensions and geometry of the tank. If such knowledge is not available, the data from the distance meter and/or image sensor can be used to establish the dimensions and geometry of the tank. By knowing the true height of the tank 26 and using computer vision algorithms to edge detection on the image obtained in 24, one skilled in the art can determine the percent height of the floating-roof by dividing the y-coordinate of the edge (in pixels) by the total height of the tank 2 (in pixels). Once this has been determined, multiplying that percent by the number established in 26 provides the height of the IFRT's 2 internal floating-roof tank, 28. The amount of petroleum then stored in the tank 2 is established in step 29 by multiplying the height obtained in 28 by the cross-sectional area of the tank 2 established in step 27. For example, as almost all IFRTs are cylindrical in geometry, the equation for calculating the volume stored within it is =(pi*radiuŝ2)*(height of floating roof).

In step 31, the individual amounts of petroleum in each container are added to the running subtotal, representing the amount of petroleum stored in all storage containers thus far processed. Once data for all the storage containers has been measured and processed, the while loop 30 breaks, and the algorithm proceeds to return the subtotal from step 23 as the final result. This result may then stored in a database along with a timestamp for historical analysis, and distributed on the Internet for sale to interested parties.

Preferred embodiments of the present invention includes network devices and interfaces that are compliant with all or part of standards proposed by the Institute of Electrical and Electronic Engineers (IEEE), International Telecommunications Union-Telecommunication Standardization Sector (ITU), European Telecommunications Standards Institute (ETSI), Internet Engineering Task Force (IETF), U.S. National Institute of Security Technology (NIST), American National Standard Institute (ANSI), Wireless Application Protocol (WAP) Forum, Bluetooth Forum, or the ADSL Forum. However, network devices and communication links based on other standards could also be used.

An operating environment for devices of the present invention include a processing system with one or more high speed Central Processing Unit(s) (CPU) or other types of processors and a memory. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU executed” or “processor executed.”

It will be appreciated that acts and symbolically represented operations or instructions include the manipulation of electrical signals by the CPU. An electrical system represents data bits which cause a resulting transformation or reduction of the electrical signals, and the maintenance of data bits at memory locations in a memory system to thereby reconfigure or otherwise alter the CPU's operation, as well as other processing of signals. The memory locations where data bits are maintained are physical locations that have particular electrical magnetic, optical, or organic properties corresponding to the data bits.

The data bits may also be maintained on a computer readable medium including magnetic disks, optical disks, organic memory, and any other volatile (e.g., Random Access Memory (RAM)) or non-volatile (e.g., Read-Only Memory (ROM)) mass storage system readable by the CPU. The computer readable medium includes cooperating or interconnected computer readable medium, which exist exclusively on the processing system or be distributed among multiple interconnected processing systems that may be local or remote to the processing system.

Although the present invention has been described above with respect to several embodiments, various modifications can be made within the scope of the present invention. For example, the steps of the flow diagrams may be taken in sequences other than those described, and more or fewer elements may be used in the block diagrams. Accordingly, the disclosure of the present invention is intended to be illustrative, but not limiting, of the scope of the invention, which is set forth in the following claims.

1. A system for monitoring the amount of petroleum present in one or more petroleum storage receptacles, comprising in combination:
an unmanned aerial vehicle positioned in proximity to a petroleum storage receptacle;
a positioning sensor on the unmanned aerial vehicle for determining the position of the unmanned aerial vehicle during flight;
a distance sensor on the unmanned aerial vehicle for measuring distances from the unmanned aerial vehicle to the top surface of the petroleum storage receptacle; a communications channel wherein data collected from the unmanned aerial vehicle is transmitted through the channel; and
a computing device that processes data collected from the unmanned aerial vehicle.

2. The system as recited in claim 1, wherein the unmanned aerial vehicle is selected from the group consisting of multi-copters, helicopters, fixed-wing aeroplanes, aerostats, and blimps.

3. The system as recited in claim 1, wherein the sensor is selected from the group consisting of laser sensors, ultrasonic sensors, infrared sensors, optical image sensors, and radio frequency sensors.

4. The system as recited in claim 1, wherein the petroleum is selected from the group consisting of crude oil, gasoline, diesel, and refined petroleum products.

5. The system as recited in claim 1, wherein the receptacle is selected from the group consisting of external floating-roof tanks, internal floating-roof tanks, and internal fixed-roof tanks.

6. A method for determining the amount of petroleum present in one or more petroleum storage receptacles, comprising the steps of:
an unmanned aerial vehicle positioning itself in proximity to each petroleum storage receptacle;
measuring she position of the unmanned aerial vehicle;
measuring the distance from the unmanned aerial vehicle to the top surface of each petroleum storage receptacle;
calculating the vertical position of the top surface of each petroleum storage receptacle by subtracting the distance from the unmanned aerial vehicle to the top surface of each petroleum storage receptacle, from the vertical height above ground level of the unmanned aerial vehicle; and
calculating the total amount of petroleum present in each petroleum storage receptacle by multiplying the vertical height of the petroleum storage receptacle's top surface by the horizontal area of the petroleum storage receptacle.
